(19) United States
(12) Patent Application Publication
(10) Pub. No.: US 2016/0328598 A1
(43) Pub. Date: Nov. 10, 2016

(54) SENSING DEVICE

(71) Applicant: Primax Electronics Ltd., Neihu (TW)

(72) Inventor: CHIA-CHU CHENG, Neihu (TW)

(21) Appl. No.: 14/923,167

(22) Filed: Oct. 26, 2015

(30) Foreign Application Priority Data
May 5, 2015 (TW) 104100059

(51) Int. Cl. G06K 9/00

(52) U.S. Cl. CPC G06K 9/00053; G06K 9/0002; G06K 9/0008

(57) ABSTRACT

A sensing device includes a protective layer and a sensing module. The sensing module is disposed under the protective layer. The protective layer is made of an isotropic dielectric material with a high dielectric constant. When a user's finger is placed on the protective layer, the sensing module acquires an information about the user's finger according to a capacitive coupling effect between the sensing module and the user's finger.

### FIELD OF THE INVENTION

The present invention relates to a sensing device, and more particularly to a capacitive sensing device.

### BACKGROUND OF THE INVENTION

Generally, capacitive sensing devices are thin and small. Consequently, capacitive sensing devices are widely used in portable electronic devices. The capacitive sensing devices are usually used to identify fingerprints or achieve the touch sensing functions. According to the principles of the capacitive sensing device, a sensing electrode is integrated into a chip, the ridges and the valleys of a user's finger touching the chip generate different capacitance values on the sensing electrode, and the fingerprint image of the user's finger or the coordinate position of the user's finger is acquired by the chip according to the capacitance values.

For protecting the chip from being over-pressed, scratched and damaged or avoiding the sweat erosion and other problems, the capacitive sensing device is usually equipped with a protective layer for covering the chip. By means of the protective layer, the user's finger cannot be in direct contact with the surface of the chip. For example, US Patent Publication No. 20140216914 discloses a capacitive sensing device. For achieving the protecting purpose, the surface of this capacitive sensing device is covered with a sapphire crystal glass layer.

Since the dielectric constant of the sapphire crystal glass is higher than the ordinary glass material, the sensing sensitivity is enhanced. However, the sapphire crystal glass is expensive and fragile, and the fabricating process of the sapphire crystal glass is complicated.

Therefore, it is an important issue to find out a cost-effective material as the protective layer in replace of the sapphire crystal glass.

### SUMMARY OF THE INVENTION

An object of the present invention provides a capacitive sensing device with enhanced sensing sensitivity and reduced cost. Moreover, the capacitive sensing device can be produced by a simplified fabricating process.

In accordance with an aspect of the present invention, there is provided a sensing device. The sensing device includes a protective layer and a sensing module. The protective layer is made of an isotropic dielectric material with a high dielectric constant. The sensing module is disposed under the protective layer. When a user's finger is placed on the protective layer, the sensing module acquires an information about the user's finger according to a capacitive coupling effect between the sensing module and the user's finger.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view illustrating the sensing device according to a first embodiment of the present invention;

FIG. 2 schematically illustrates plural sensing elements of a sensing module of the sensing device according to the first embodiment of the present invention;

FIG. 3 schematically illustrates the sensing device of the first embodiment in a usage state, in which a user's finger is placed on the protective layer; and

FIG. 4 schematically illustrates a sensing circuit layer of a sensing module of a sensing device according to a second embodiment of the present invention.

### DETAILED DESCRIPTION OF THE PREFERRED EMBODIMENT

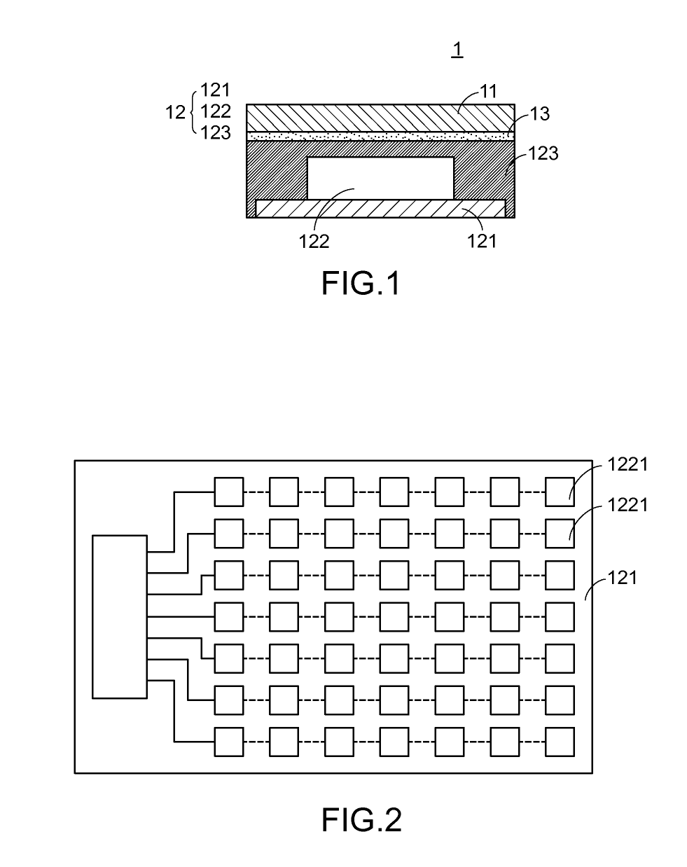

Hereinafter, the components of a sensing device 1 according to a first embodiment of the present invention will be illustrated with reference to FIGS. 1 and 2. FIG. 1 is a schematic cross-sectional view illustrating the sensing device according to the first embodiment of the present invention. FIG. 2 schematically illustrates plural sensing elements of a sensing module of the sensing device according to the first embodiment of the present invention. The sensing device 1 comprises a protective layer 11 and a sensing module 12. The protective layer 11 is made of an isotropic dielectric material with a high dielectric constant. This high dielectric constant is higher than the dielectric constant of the sapphire crystal glass. In an embodiment, the isotropic dielectric material with the high dielectric constant is a ceramic material. An example of the ceramic material includes but is not limited to zirconium dioxide. The dielectric constant of the ceramic material is close to 30, which is much higher than the dielectric constant of the sapphire crystal glass (e.g. about 10). Since the ceramic material has the high dielectric constant, the intensity of the electric signal received by the sensing module 12 is strengthened and the sensing sensitivity thereof is enhanced. The reasons will be illustrated later.

The sensing module 12 is disposed under the protective layer 11. In this embodiment, the sensing module 12 is a fingerprint identification chip. Moreover, the fingerprint identification chip comprises a substrate 121, a sensing die 122 and a package shell 123. The sensing die 122 is disposed on the substrate 121. The sensing die 122 comprises plural sensing elements 1221. In addition, the plural sensing elements 1221 are collaboratively defined as an electrode layer.

As known, wafer is a basic material for fabricating an integrated circuit (IC). Generally, wafer is made of a semiconductor material such as silicon (Si) or gallium arsenide (GaAs). Preferably but not exclusively, the sensing die 122 is obtained from silicon wafer. Moreover, the substrate 121 and the sensing die 122 are encapsulated within the package shell 123. Consequently, the substrate 121 and the sensing die 122 are protected by the package shell 123. In this embodiment, the package shell 123 is made of epoxy resin, but is not limited thereto. Moreover, the packaging method is implemented by a pin through hole (PTH) technology, a surface mount technology (SMT) or any other appropriate conventional packaging technology. The packaging method is known in the art, and is not redundantly described herein.

Moreover, the protective layer 11 is attached on the package shell 123 of the sensing module 12 via a connecting article 13. The protective layer 11 is aligned with the sensing die 122. In this embodiment, the connecting article 13 is an insulating material. An example of the connecting article 13 includes but is not limited to an adhesive or a double side tape.

It is noted that numerous modifications and alterations may be made while retaining the teachings of the invention. For example, in another embodiment, the substrate 121 and the sensing die 122 are not encapsulated within the package shell 123. That is, the protective layer 11 is directly attached on the sensing die 122.

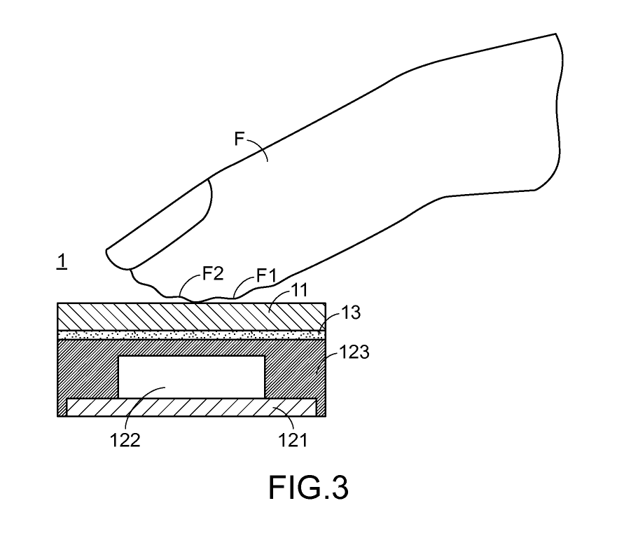

Hereinafter, the operating principles of the sensing device 1 of the first embodiment will be illustrated with reference to FIG. 3. FIG. 3 schematically illustrates the sensing device of the first embodiment in a usage state, in which a user's finger is placed on the protective layer. Generally, the human body is an electric conductor. Consequently, when a user's finger F is placed on the protective layer 11, the user's finger F may be considered as another electrode layer. Meanwhile, a capacitive coupling effect occurs between the user's finger F and the plural sensing elements 1221. Moreover, each point on the surface of the user's finger F corresponds to a sensing element 1221. Since the surface of the user's finger F comprises plural ridges F1 and plural valleys F2, the distances of each point on the surface of the user's finger F from the sensing elements 1221 are not completely identical. That is, the intensities of the electric signals sensed by all of the sensing elements 1221 are not completely identical. Consequently, the sensing module 12 can realize the distances between all of the sensing elements 1221 and the surface of the user's finger F. According to these distances, the fingerprint image information corresponding to the surface of the user's finger F including the plural ridges F1 and the plural valleys F2 can be obtained.

As mentioned above, the protective layer 11 is made of the isotropic dielectric material with the high dielectric constant. For example, the isotropic dielectric material with the high dielectric constant is a ceramic material. Since the dielectric constant of the ceramic material is close to 30, the protective layer 11 can provide a larger capacitance value. When the capacitive coupling effect between the user's finger F and the plural sensing elements 1221 occurs, the intensity of the electric signal received by the sensing module 12 according to the capacitance value becomes stronger. Consequently, the sensing sensitivity is enhanced.

Moreover, the capacitance value provided by the protective layer 11 is determined according to the thickness and the dielectric constant of the protective layer 11. That is, the product of the capacitance value and the thickness is equal to the dielectric constant. If the dielectric constant is higher, the capacitance value is higher when the thickness is fixed. Consequently, the protective layer 11 can provide a larger capacitance value while maintaining slim.

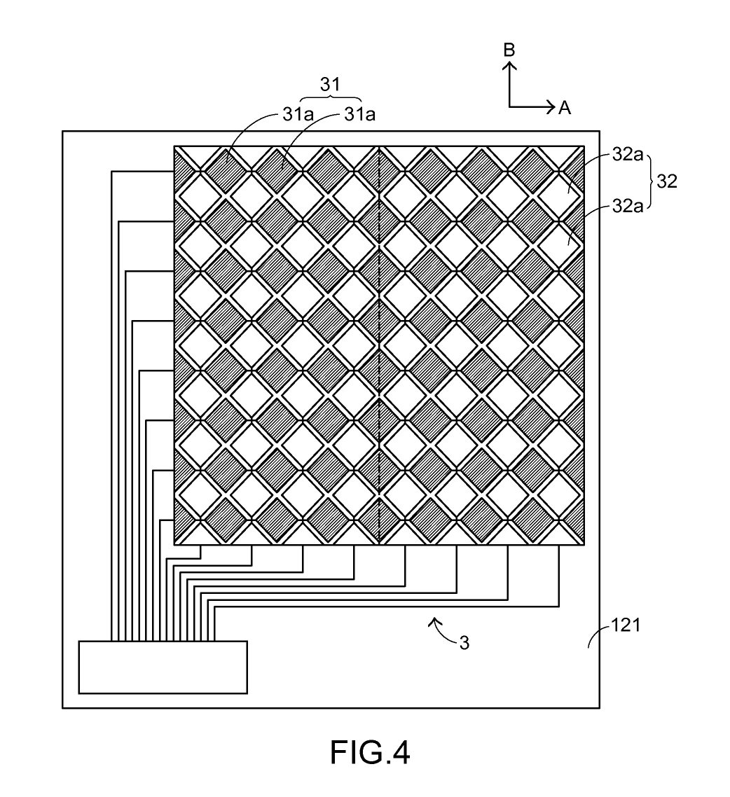

Hereinafter, a portion of a sensing device according to a second embodiment of the present invention will be illustrated with reference to FIG. 4. FIG. 4 schematically illustrates a sensing circuit layer of a sensing module of the sensing device according to the second embodiment of the present invention. In comparison with the first embodiment, the sensing module 12 of the sensing device of this embodiment is a touch sensing chip. Consequently, the plural sensing elements 122 of the sensing module of the first embodiment are replaced by the sensing circuit layer 3 of the sensing module of this embodiment (see FIG. 4). In this embodiment, the sensing circuit layer 3 comprises a first electrode layer 31 and a second electrode layer 32. The first electrode layer 31 and the second electrode layer 32 are sequentially formed on the substrate 121.

The first electrode layer 31 comprises plural first electrode circuit patterns 31a, which are arranged along a first direction A (e.g. an X-axis direction). The second electrode layer 32 comprises plural second electrode circuit patterns 32a, which are arranged along a second direction B (e.g. a Y-axis direction). Moreover, each second electrode circuit pattern 32a is located beside the adjacent first electrode circuit patterns 31a.

When the sensing circuit layer 3 is electrically conducted, an electric field between each first electrode circuit patterns 31a and the corresponding second electrode circuit pattern 32a is generated. When the user's finger F is placed on the protective layer 11, the electric field under the user's finger F is subjected to a change according to the capacitive coupling effect between the user's finger F and the sensing circuit layer 3. According to the position of the first electrode circuit pattern 31a and the second electrode circuit pattern 32a corresponding to the changed electric field, the sensing module 12 acquires the coordinate information of the user's finger F.

In this embodiment, the first electrode layer 31 and the second electrode layer 32 are made of an electrically-conductive material. An example of the electrically-conductive material includes but is not limited to indium tin oxide (ITO), indium zinc oxide, aluminum zinc oxide, conductive polymeric material, graphene, silver bromide (AgBr), indium gallium zinc oxide (IGZO), carbon nanotube, nano silver or nano Cu.

The other contents of the second embodiment are similar to those of the first embodiment, and are not redundantly described herein.

From the above descriptions, the protective layer 11 of the sensing device of the present invention is made of the isotropic dielectric material with the high dielectric constant. For example, the isotropic dielectric material with the high dielectric constant is a ceramic material. The dielectric constant of the isotropic dielectric material is close to 30, which is much higher than the dielectric constant of the sapphire crystal glass (e.g. about 10). Consequently, the protective layer 11 can provide a larger capacitance value without the need of increasing the thickness. Under this circumstance, the intensity of the electric signal received by the sensing module 12 is strengthened and the sensing sensitivity thereof is enhanced. Moreover, since the brittleness of the ceramic material is lower than that of the sapphire crystal glass, the protective layer 11 may be made thinner and less fragile. Moreover, since the ceramic material bears color, the procedure for coloring the protective layer 11 to make the sensing module 12 invisible can be omitted. Consequently, the complexity of the fabricating process is reduced. Moreover, since the ceramic material is more cost-effective and the fabricating process is simplified, the fabricating cost is reduced and the throughput is increased.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A sensing device, comprising:
a protective layer made of an isotropic dielectric material with a high dielectric constant; and
a sensing module disposed under the protective layer, wherein when a user's finger is placed on the protective layer, the sensing module acquires an information about the user's finger according to a capacitive coupling effect between the sensing module and the user's finger.

2. The sensing device according to claim 1, wherein the sensing module is encapsulated within a package shell.

3. The sensing device according to claim 2, wherein the package shell is made of epoxy resin.

4. The sensing device according to claim 1, wherein the sensing module is a fingerprint identification chip.

5. The sensing device according to claim 4, wherein the sensing module comprises a sensing die, and the sensing die comprises plural sensing elements, wherein the plural sensing elements are collaboratively defined as an electrode layer, and the protective layer is aligned with the sensing die.

6. The sensing device according to claim 5, wherein the sensing module senses electric signals with different intensities according to the capacitive coupling effect between the plural sensing elements and ridges and valleys on a surface of the user's finger, and the sensing module acquires a fingerprint image information corresponding to the user's finger according to the electric signals.

7. The sensing device according to claim 1, wherein the sensing module is a touch sensing chip.

8. The sensing device according to claim 7, wherein the sensing module comprises a sensing circuit layer, wherein the sensing circuit layer comprises a first electrode layer and a second electrode layer, and the protective layer is aligned with the sensing circuit layer.

9. The sensing device according to claim 8, wherein the first electrode layer comprises plural first electrode circuit patterns, and the second electrode layer comprises plural second electrode circuit patterns, wherein an electric field is generated between each of the first electrode circuit patterns and the corresponding second electrode circuit pattern, and the electric field is changed according to the capacitive coupling effect between the sensing circuit layer and the user's finger, wherein the sensing module acquires a coordinate information of the user's finger according to a position corresponding to the changed electric field.

10. The sensing device according to claim 1, wherein the isotropic dielectric material of the protective layer with the high dielectric constant is a ceramic material.

11. The sensing device according to claim 10, wherein the ceramic material is zirconium dioxide.

12. The sensing device according to claim 1, further comprising a connecting article, wherein the connecting article is arranged between the protective layer and the sensing module.
